(19) United States
(12) Patent Application Publication
(10) Pub. No.: US 2022/0003534 A1
(43) Pub. Date: Jan. 6, 2022

(54) Interferometer Device and Method for Producing an Interferometer Device

(71) Applicant: Robert Bosch GmbH, Stuttgart (DE)

(72) Inventors: Benedikt Stein, Stuttgart (DE); Martin Husnik, Stuttgart (DE); Christoph Schelling, Stuttgart (DE); Thomas Buck, Tamm (DE); Christoph Daniel Kraemmer, Karlsruhe (DE); Reinhold Roedel, Reutlingen (DE)

(21) Appl. No.: 17/294,950

(22) PCT Filed: Nov. 12, 2019
(86) PCT No.: PCT/EP2019/080930

§ 371 Date: May 18, 2021

(30) Foreign Application Priority Data
Nov. 26, 2018 (DE) 10 2018 220 272.9

(51) Int. Cl. G01B 9/02; G02B 5/28; G02B 26/00

(52) U.S. Cl. CPC G01B 9/02; G01B 2290/25; G02B 26/007; G02B 5/288

(57) ABSTRACT

The disclosure relates to an interferometer including a substrate, and an intermediate layer region applied on the substrate. A first mirror device and a second mirror device are aligned plane-parallel with one another and are separated from one another by a first distance and are framed in or on the intermediate layer region, the intermediate layer region removed in at least one of an inner region below the first mirror device and below the second mirror device. A laterally structured electrode including a first subregion and a second laterally separated subregion which are configured to be connected to different electrical potentials. The electrode arranged at a second distance from the first or the second mirror device, the first subregion extending in the inner region and arranged on the intermediate layer region and the second subregion extending in an outer region of the intermediate layer region.

The present invention relates to an interferometer device and to a method for producing an interferometer device.

### PRIOR ART

For the miniaturization of tunable spectral filters, Fabry-Perot interferometers (FPIs) may advantageously be produced in MEMS technology. In this case, use is made of the fact that a cavity consisting of two highly reflective plane-parallel mirrors with a spacing (cavity length) in the range of optical wavelengths exhibits a high transmission only for wavelengths at which the cavity length corresponds to an integer multiple of half the wavelength. The cavity length may for example be modified by means of electrostatic or piezoelectric actuation, so that a spectrally tunable filter element is obtained. A large number of known FPIs use electrostatic actuation of the mirrors (in contrast to the above-mentioned piezoelectric actuation), the mirrors often being configured as membranes. In this case, a voltage is applied between two electrodes that are located at the level of the two mirrors, so that the two mirrors move toward one another because of the electrostatic attraction. Conventional membrane mirrors comprise at least one partially conductive semiconductor material.

Since, in the case of membrane mirrors, the membrane material is conventionally also present in large areas outside the actuation region, this may generate high parasitic capacitances which may make position detection more difficult, and at best only make it slower, and can increase the electricity consumption. Furthermore, actuation in the constant-charge mode thus becomes impossible.

WO15002028 describes a Fabry-Perot filter that comprises an electrode on one of the mirrors, the electrode comprising a plurality of partial electrodes so that different electrical potentials can be applied on the same membrane, for instance by locally different doping. This may however generate charging effects of pn junctions (voltage-dependent parasitic capacitances) and cause leakage currents. Furthermore, the optical region must also be at least weakly doped, which may impair the optical quality of the layers.

### DISCLOSURE OF THE INVENTION

The present invention provides an interferometer device as claimed in claim 1 and a method as claimed in claim 11 for producing an interferometer device.

Preferred developments are the subject matter of the dependent claims.

### Advantages of the Invention

The underlying concept of the present invention is to provide an interferometer device and a method for producing an interferometer device, which are distinguished by an actuation electrode that is separated from the mirrors and is electrically insulated from them. Different electrical potentials can be applied onto the electrode on a plurality of subregions, and parasitic capacitances in the interferometer device are advantageously reduced.

According to the invention, the interferometer device comprises a substrate; an intermediate layer region, which is applied on the substrate; a first mirror device and a second mirror device, which are aligned plane-parallel with one another and are separated from one another by a first distance and are framed in the intermediate layer region or are arranged thereon, the intermediate layer region being removed in an inner region below the first mirror device and/or below the second mirror device; and a laterally structured electrode, which comprises a first subregion and at least one second subregion laterally separated therefrom and electrically insulated, which subregions can be connected to different electrical potentials, the electrode being arranged at a second distance from the first or the second mirror device, the first subregion extending in the inner region and being arranged on the intermediate layer region and the second subregion extending in an outer region of the intermediate layer region, so that the first mirror device and/or the second mirror device is movable electrostatically and parallel to the substrate through the first subregion in the inner region and the first distance can be varied.

The intermediate layer region may advantageously be that region of a material of a sacrificial layer which remains in a structured region after structuring and partial removal of the material of the sacrificial layer. The material of the intermediate layer region is advantageously etchable and electrically insulating.

By the separation from the mirror devices and from the substrate and by the arrangement and embedding of the electrode in and on the intermediate layer region, the electrode may advantageously be electrically insulated both from the substrate and from the mirror devices. By the separation and the subdivision into at least two laterally separated and mutually insulated subregions, parasitic capacitances may advantageously be reduced by the electrode. The first subregion may act as an actuation electrode for the first and/or second mirror device. To this end, the first and/or second mirror device itself may comprise an actuation electrode, which may be arranged or framed on the mirror device, or the mirror device may itself be electrically conductive and connected to a potential required for the actuation. The electrode may be located over, under or between the first or second mirror device. If the electrode is located between or under the mirror devices, the second and further subregions may be framed in the outer region in the intermediate layer region and anchored there, i.e. they cannot themselves initiate any actuation. If the electrode is arranged over the mirror devices, it may be arranged fully on the intermediate layer region and be exposed on an upper side.

By means of the at least two subregions of the electrode and the different potentials, parasitic capacitances in the interferometer device may advantageously be reduced. The interferometer device may be a Fabry-Perot interferometer. The connection or framing of the mirror devices with the intermediate layer region advantageously serves as mechanical anchoring of the mirrors on the substrate and as electrical insulation. The mirror devices freed in the inner region act as membrane mirrors. The separated electrodes advantageously extend in a different plane than the two mirror devices. As a counter-electrode for the electrode, one or both mirror devices may comprise a separate electrode, which is arranged on the mirror device (for example metallic material) or is contained therein, for instance by doping of a local region of the mirror device (of a semiconductor material of the mirror device), or may itself be electrically conductive. Likewise, the electrode itself may be provided with first and further subregions as a metal layer or doped semiconductor material, possibly also on its own carrier layer. The counter-electrode may be mechanically connected to the mirror device and induce a parallel deflection of the mirror device, in particular of a central zone (optical region) of the inner region.

It is furthermore possible for an area electrically insulated from the laterally structured electrode to be produced inside the latter from the same layer.

In particular, by the lateral separation of potentials on the subregions of the electrode, parasitic capacitances between the mirrors and the electrode may be reduced. By reduced parasitic capacitances, position detection of the mirrors and the electrode with respect to one another may advantageously be improved, which facilitates or allows constant-charge actuation. Position detection may, for example, be performable by means of capacitive or piezoresistive detection. The constant-charge actuation may be an actuation scheme in which the charge on the actuator capacitance is controlled instead of the voltage at the actuator.

Furthermore, losses from recharging of decreased parasitic capacitances may be reduced and an electricity consumption may be lowered. Recharging may in this case be understood as meaning that, in the case of capacitive detection or actuation by means of an AC voltage, charging and discharging of the actuator capacitance may repeatedly take place.

Leakage currents may advantageously be reduced by means of the laterally separated potentials on the electrode.

Furthermore, no lateral variation of doping of one or more electrode layers (regions) and therefore no formation of pn junctions are necessary, which may advantageously result in smaller voltage-dependent effects.

The mirror devices may be constructed differently or identically, and may comprise a single layer or a plurality of layers and/or a mechanical carrier layer with mirror layer(s) arranged thereon. The mirror device(s) may furthermore also have a tensile prestress, so that the planarity of the mirrors can be improved.

The substrate may for example be formed as a wafer, in particular as a MEMS wafer, and the interferometer device may be formed as a MEMS component. The MEMS wafer may advantageously be capped on one or both sides.

According to one preferred embodiment of the interferometer device, the electrode comprises in the inner region a recess in an optical region of the interferometer device, and the first subregion and the second subregion extend laterally around the recess at least partially.

The optical region is advantageously that central region of the inner region in which electromagnetic radiation can be reflected or transmitted by the mirror devices.

According to one preferred embodiment of the interferometer device, the electrode comprises a ring electrode.

According to one preferred embodiment of the interferometer device, the subregions of the electrode are fully separated laterally from one another and electrically insulated from one another by separating trenches.

The separating trenches may fully separate the material of the electrode, advantageously in the vertical direction.

According to one preferred embodiment of the interferometer device, the first and/or the second mirror device comprise a Bragg mirror or a metal mirror.

According to one preferred embodiment of the interferometer device, the first distance is less than the second distance.

As Bragg mirrors, the mirror device may for example comprise a material combination (a plurality of layers, advantageously alternating) such as silicon-air, Si—SiN (silicon and silicon nitride), Si—SiO₂ (silicon-silicon oxide), Si—SiCN (silicon-silicon carbonitride), Si—SiC (silicon-silicon carbide), TiO₂—SiO₂ (titanium oxide-silicon oxide) or the like. As metal mirrors, it may comprise one or more layers of Ag (silver), Cu (copper), Au (gold) or the like.

According to one preferred embodiment of the interferometer device, the first subregion comprises a bearing region, which is laterally electrically insulated, and wherein the first or the second mirror device faces directly toward the electrode and comprises abutment studs in the inner region, which extend away from a mirror surface of the electrode and can be placed on the bearing region in the event of actuation.

According to one preferred embodiment of the interferometer device, the first and/or the second mirror device comprise an undoped material in the inner region.

If the material of the mirror devices has no doping or only weak doping, particularly in the inner region and in the optical region, which may be configured for the resonator action of the Fabry-Perot interferometer, a parasitic optical absorption in this region may advantageously be reduced and in general the optical properties of the inner region may be improved.

According to one preferred embodiment of the interferometer device, it comprises an etch stop, which forms a side wall at the intermediate layer region laterally between the inner region and the outer region.

According to one preferred embodiment of the interferometer device, the first and/or the second mirror device are connected to an electrical potential.

According to the invention, in the method for producing an interferometer device, a substrate and a first sacrificial layer on the substrate are provided; an electrode is applied onto the first sacrificial layer and the electrode is structured into a first subregion and at least one second subregion separated laterally and electrically therefrom; a second sacrificial layer is applied onto the electrode and onto the first sacrificial layer; a first mirror device is arranged on the second sacrificial layer; a third sacrificial layer is applied on the first mirror device; a second mirror device is arranged on the third sacrificial layer in a plane-parallel fashion over the first mirror device at a first distance; and the second sacrificial layer and the third sacrificial layer are removed in an inner region below the first and the second mirror device by means of an etching method, the inner region extending at least over a part of the first subregion, and a region, remaining in the interferometer device, of the first sacrificial layer, of the second sacrificial layer and of the third sacrificial layer forming an intermediate layer region so that the first mirror device and the second mirror device are framed in an outer region of the intermediate layer region or are arranged thereon, and the first subregion extends fully or partly in the inner region and is arranged on the intermediate layer region, and the second subregion extends in the outer region of the intermediate layer region.

The second subregion may extend laterally around the first subregion.

The inner region may extend at least over a part of the first subregion.

Furthermore, the first sacrificial layer may be removed at least locally in the region of the optical region.

The method may furthermore be distinguished by the features already mentioned in connection with the interferometer device and the advantages thereof, and vice versa.

The structuring may, for example, be carried out by an exposure and etching method.

According to one preferred embodiment of the method, a recess is formed in the first subregion and in an optical region of the interferometer device, and the first sacrificial layer is removed in this recess.

The first sacrificial layer below the electrode may have a lower etching rate for the sacrificial layer etching than the second and third sacrificial layers. In this way, undercut etching of the electrode may be reduced or avoided. To this end, a corresponding selection of the material of the first sacrificial layer may be carried out.

Further features and advantages of embodiments of the invention may be found from the following description with reference to the appended drawings.

### BRIEF DESCRIPTION OF THE DRAWINGS

The present invention will be explained in more detail below with the aid of the exemplary embodiment given in the schematized figures of the drawing, in which:

FIG. 1 shows a schematized lateral cross section of an interferometer device according to one exemplary embodiment of the present invention;

FIG. 2a shows a schematized lateral cross section of an interferometer device according to a further exemplary embodiment of the present invention;

FIG. 2b shows a schematized lateral cross section of an interferometer device according to a further exemplary embodiment of the present invention;

FIG. 3 shows a plan view of an electrode according to one exemplary embodiment of the present invention; and

FIG. 4 shows a block diagram of the method steps according to the present invention.

In the figures, references that are the same denote elements that are the same or functionally equivalent.

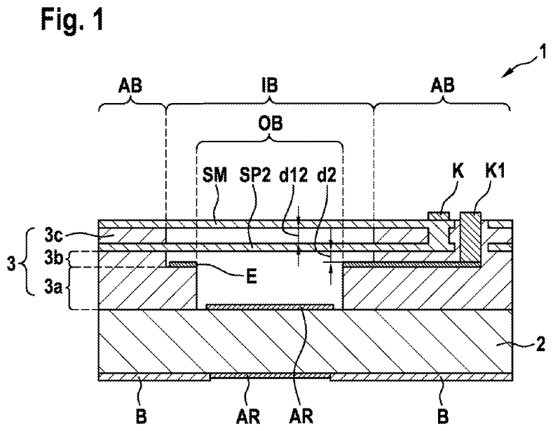

FIG. 1 shows a schematized lateral cross section of an interferometer device according to one exemplary embodiment of the present invention.

The interferometer device 1 comprises a substrate 2; an intermediate layer region 3, which is applied on the substrate 2; a first mirror device SP1 and a second mirror device SP2, which are aligned plane-parallel with one another and are separated from one another by a first distance d12 and are framed in the intermediate layer region 3 or are arranged thereon, the intermediate layer region 3 being removed in an inner region IB below the first mirror device SP1 and/or below the second mirror device SP2; and a laterally structured electrode E, which comprises a first subregion E1 and at least one second subregion (not shown) laterally separated therefrom and electrically insulated, which subregions can be connected to different electrical potentials, the electrode E being arranged at a second distance d2 from the first or the second mirror device SP1; SP2, the first subregion E1 extending in the inner region IB and being arranged on the intermediate layer region 3a and the second subregion E2 extending in an outer region AB of the intermediate layer region 3, so that the first mirror device SP1 and/or the second mirror device SP2 is movable electrostatically and parallel to the substrate 2 through the first subregion E1 in the inner region IB and the first distance d12 can be varied. FIG. 1 shows a cross section of a contact guide from the first subregion E1 through the intermediate region 3, and for example, to the intermediate region 3a, and to the through-contact K1 thereof, which runs through the intermediate region 3b and 3c. By the actuation, a substantially parallel deflection of one of the mirror devices SP1, SP2 relative to the other mirror device may be carried out in the inner region, and particularly in the optical region OB.

By variation of the distance of the mirror devices from one another, a transmission wavelength of the interferometer device (Fabry-Perot interferometer) can be modified.

The inner region IB may advantageously correspond to that region in which the second and third sacrificial layers 3b and 3c have been removed, i.e. the mirror devices SP1 and SP2 are freed. The intermediate layer region 3 may therefore constitute anchoring of the mirror devices and of the electrode in the outer region AB and fasten them on the substrate 2 mechanically and in an electrically insulated fashion. The first subregion E1 may be arranged on a residual region of the first sacrificial layer 3a, i.e. on a residual portion of the intermediate layer region 3, which may extend into the inner region IB under the first subregion E1. FIG. 1 shows a recess in the optical region OB, which recess may extend from the mirror devices to the substrate 2 and in which recess the electrode is also removed or was not initially formed there. An antireflective layer AR may be arranged on the substrate 2, for example on both sides, in the optical region OB. On an underside of the substrate 2, a mask B, by which light incidence or emergence and for instance the angle thereof can be influenced or filtered may be arranged outside the optical region. The second subregion of the electrode may advantageously be embedded into the intermediate layer region and enclosed by it on both sides. Contacting K of the mirror device, and advantageously of that embedded in the intermediate layer region, may be carried out from the upper side by means of a contact K through the intermediate layer region. The contacting of the subregion E1 may also be fed by means of a through-contact, for instance from an upper side of the intermediate layer region, through the latter. The arrangement of the contacts is represented merely by way of example and may be adapted in respect of the specific electrode arrangement. By means of the first subregion E1, the closest mirror device may therefore be actuated by the potential applied to the first subregion E1 and by means of a counter-electrode of the mirror device, so that the central region of the mirror device in the region of the optical region can be deflected parallel to the other mirror device. Deformation of the mirror device during actuation advantageously takes place primarily in the inner region IB but outside the optical region, so that mirror planarity and parallelism in the optical region can be promoted. For this effect, with this structure, lateral presence of different potentials on the mirror device is advantageously not necessary, which may represent a significant simplification of production. Over the first subregion E1, the mirror device may comprise its own electrode as a separate actuation electrode, which however may also be framed in the mirror device or formed there.

A separate electrode may, for example, be formed on the mirror device by deposition of an electric material or structuring of a conductive layer on the mirror device, or deliberate doping of a semiconductor material (for instance silicon). A significant reduction of the parasitic capacitances may be achieved by a reduction of the areas contributing to the capacitance (only necessary regions formed as electrodes). The separate electrode may, for example, be configured as a ring. In the case of forming an electrode region in the mirror device (for instance with doping), the parasitic capacitance may be restricted to a small area of the contact and a supply line to the counter-electrode.

Bending of the electrode may, for example, be prevented or reduced by a sufficient stiffness of the intermediate layer region 3, to which end the intermediate layer region 3 may have a sufficient thickness.

The basic distance d12 before the actuation may be known for the corresponding interferometer.

The reflectivity of the mirror devices SP1 and SP2 may, for example, be produced by metal layers on carrier membranes or a dielectric DBR membrane stack (Bragg mirror).

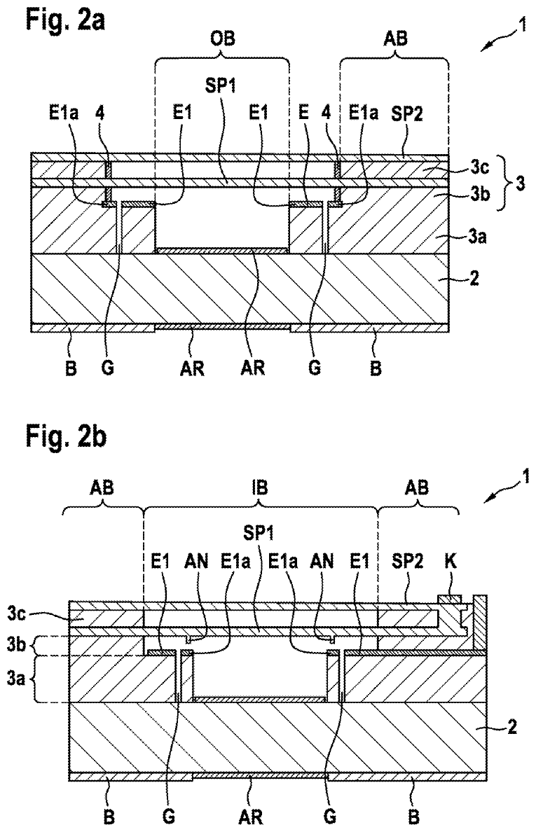

FIG. 2a shows a schematized lateral cross section of an interferometer device according to a further exemplary embodiment of the present invention.

The embodiment of FIG. 2a differs from FIG. 1 only by the etch stop 4 and by the bearing region E1a. The first subregion E1 may comprise a bearing region E1a, which is laterally electrically insulated from the other subregions of the electrode E and E1, and wherein the first or the second mirror device SP1; SP2 faces directly toward the electrode E.

The bearing region E1a may be delimited and insulated from the first subregion E1 by a trench G in the intermediate layer region 3. The trench G may extend through the intermediate layer region 3 as far as the substrate 2.

Antireflection layers AR may be arranged on all interfaces in the optical path that are not part of the mirror devices. By the masks B, it is possible to form an optical region OB which may delimit the optical light path and the angle of incidence by reflection and/or absorption.

In the intermediate layer region 3, an etch stop 4, which may for example comprise the material of one of the mirror devices SP1, SP2, may be formed on a side wall laterally between the inner region IB and the outer region AB. The etch stop may therefore already belong to the outer region AB. Furthermore, there may be a possibility for protection against undefined undercut etching in sacrificial layer processes. This etch stop 4 may be formed during production as a trench in the second and third sacrificial layers 3b and 3c and be filled with the mirror material, and have a lower etching rate than the sacrificial layers. Such an etch stop layer may also be formed on a side wall of the intermediate layer region of the first sacrificial layer, for instance toward the optical region (not shown). This may likewise be produced by trench formation. Any topographies generated, protruding vertically beyond the electrode or the mirror device, could be compensated for by methods of thinning back. Precise definition of the membrane clampings of the mirror devices may be achieved by the etch stop 4, since this is usually determined by how far the membranes are freed during the sacrificial layer process, which is typically subject to large variations. In this way, any nonideal arrangement of the etching accesses as well as a varying etching rate may likewise be compensated for. The etch stop 4 may be produced during production in such a way that it can be drawn down onto the bearing region E1a. Between the first subregion E1 and the second subregion, there may also be a trench in the intermediate layer region 3 below the electrode E (this is not shown). This may lead to significantly simplified process management during production. In the case of a mirror membrane which does not contain a layer that is electrically insulating and at the same time sufficiently resistant to the sacrificial layer etching (which is often the case), in order to achieve an etch stop, in a conventional process sequence it would otherwise be necessary to deposit at least one additional layer and structure it in such a way that no perturbing topography is formed. Such etch stops may also be formed in other regions of the interferometer device, for example in the region of electrical contacts and feeds.

FIG. 2b shows a schematized lateral cross section of an interferometer device according to a further exemplary embodiment of the present invention.

FIG. 2b differs from FIG. 2a in that in FIG. 2b no etch stop is shown and abutment studs AN of the first mirror device SP1 may protrude from the latter in the direction of the electrode E1. Furthermore, there may be further insulated regions E1a (bearing regions) of the electrode E, onto which it is possible to place (during actuation) abutment studs, which may extend away from a mirror surface to the electrode E and can be placed onto the insulated region during actuation. The abutment studs AN can prevent contact of the mirror device SP1; SP2 and the electrode E and generally limit the deflection of the mirror device, may themselves be electrically conductive and may be placed outside the potential of the actuation electrode E1. If contact of the abutment studs with the electrode E1 nevertheless takes place in the insulated region E1a, this may be released again easily. By means of the abutment studs, it is possible to prevent welding to the tips of the abutment studs taking place in the event of contact with the electrode E in the insulated region and an electrical voltage applied to the first subregion E1, the abutment studs conventionally either needing to be electrically separated from the rest of the mirror potential or needing to consist of an insulator. According to the invention, the abutment studs may comprise a conductive material or the material of the mirror device, which may lead to simplified process management. The bearing regions E1a may be laterally adjacent directly to the optical region or lie further out in the inner region IB.

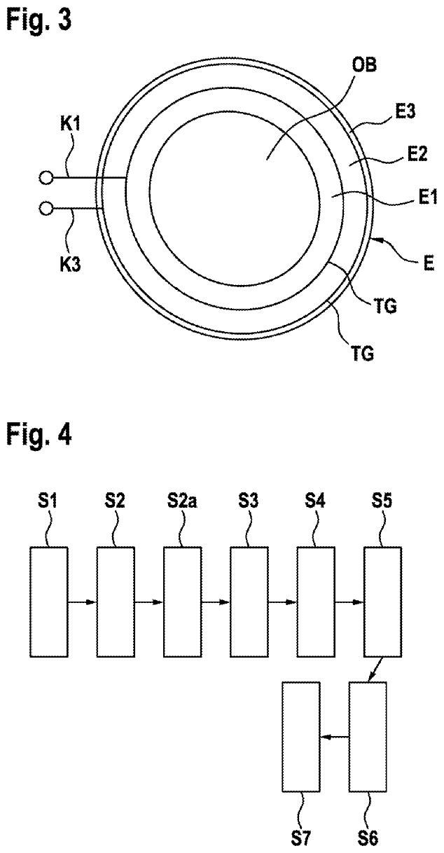

FIG. 3 shows a plan view of an electrode according to one exemplary embodiment of the present invention.

The electrode E may comprise a ring electrode with a recess in the middle, i.e. for the optical region of the interferometer device. By suitable structuring of the conductive layers into subregions E1, E2 and so on, different potentials may be applied laterally separately from one another by the contacts K1, K2, for example from above. These contacts may be drop-shaped, round, rectangular or shaped in the form of a polygon. Lateral insulation of the individual subregions, which may constitute rings, may be achieved by separating trenches TG, by which an interruption of the ring structures may be obtained. In this case, so-called feed-throughs may be formed. In addition, a conductive layer, for example in the electrode layer E, may be used as a buried conductive track of a contact K1, K2, K3 in order to produce contacting below other conductive layers and optionally contact these by means of the buried conductive track. This may be achieved by subsequent deposition of an insulator layer. The electrical contacts may in general also be produced in another way.

FIG. 4 shows a block diagram of the method steps according to the present invention.

In the method for producing an interferometer device, a substrate and a first sacrificial layer on the substrate are provided S1; an electrode is applied S2 onto the first sacrificial layer and the electrode is structured S2a into a first subregion and at least one second subregion separated laterally and electrically therefrom, which extends laterally around the first subregion; a second sacrificial layer is applied S3 onto the electrode and onto the first sacrificial layer; a first mirror device is arranged S4 on the second sacrificial layer; a third sacrificial layer is applied S5 on the first mirror device; a second mirror device is arranged S6 on the third sacrificial layer in a plane-parallel fashion over the first mirror device at a first distance; and the second sacrificial layer and the third sacrificial layer are removed S7 in an inner region below the first and the second mirror device by means of an etching method, the inner region extending over the first subregion, and a region, remaining in the interferometer device, of the first sacrificial layer, of the second sacrificial layer and of the third sacrificial layer forming an intermediate layer region so that the first mirror device and the second mirror device are framed in an outer region of the intermediate layer region or are arranged thereon, and the first subregion extends in the inner region and is arranged on the intermediate layer region, and the second subregion extends in the outer region of the intermediate layer region.

Furthermore, a recess may be formed in the first subregion and in an optical region of the interferometer device, and the first sacrificial layer may be removed in this recess. The formation of the recess may already take place during the arrangement or provision of the electrode. It is likewise possible for the method steps to be carried out in an order other than that mentioned. For example, the electrode may be arranged between the mirror devices or over them as an upwardly closing element, i.e. on the third sacrificial layer or between the second and third sacrificial layers.

The present invention has been fully described above with the aid of the preferred exemplary embodiment, it is not restricted thereto but may be modified in a variety of ways.

1. An interferometer device, comprising:
a substrate;
an intermediate layer region applied on the substrate;
a first mirror device and a second mirror device, which are aligned plane-parallel with one another and are separated from one another by a first distance and are framed in the intermediate layer region or are arranged thereon, the intermediate layer region removed in at least one of an inner region below the first mirror device and/or below the second mirror device; and
a laterally structured electrode including a first subregion and at least one second subregion laterally separated therefrom and electrically insulated, which subregions are configured to be connected to different electrical potentials, the electrode arranged at a second distance from the first or the second mirror device, the first subregion extending in the inner region and being arranged on the intermediate layer region and the second subregion extending in an outer region of the intermediate layer region, such that at least one of the first mirror device and the second mirror device is movable electrostatically and parallel to the substrate through the first subregion in the inner region and such that the first distance is variable.

2. The interferometer device as claimed in claim 1, wherein the electrode comprises in the inner region a recess in an optical region of the interferometer device, and the first subregion and the second subregion laterally extend around the recess at least partially.

3. The interferometer device as claimed in claim 1 or 2, wherein the electrode comprises a ring electrode.

4. The interferometer device as claimed in claim 1, wherein the subregions of the electrode are fully separated laterally from one another and electrically insulated from one another by respective separating trenches.

5. The interferometer device as claimed in claim 1, wherein at least one of the first and the second mirror device comprises one of a Bragg mirror and a metal mirror.

6. The interferometer device as claimed in claim 1, wherein the first distance is less than the second distance.

7. The interferometer device as claimed in claim 1, wherein the first subregion comprises a bearing region which is laterally electrically insulated, and wherein one of the first and the second mirror device faces directly toward the electrode and comprises abutment studs in the inner region which extend away from a mirror surface of the electrode and are configured to be placed on the bearing region when the electrode is actuated.

8. The interferometer device as claimed in claim 1, wherein at least one of the first and the second mirror device comprises an undoped material in the inner region.

9. The interferometer device as claimed in claim 1, further comprising:
an etch stop, which forms a side wall at the intermediate layer region laterally between the inner region and the outer region.

10. The interferometer device as claimed in claim 1, wherein at least one of the first and the second mirror device are connected to an electrical potential.

11. A method for producing an interferometer device, comprising:
providing a substrate and a first sacrificial layer on the substrate;
applying an electrode onto the first sacrificial layer and structuring the electrode into a first subregion and at least one second subregion separated laterally and electrically therefrom;
applying a second sacrificial layer onto the electrode and onto the first sacrificial layer;
arranging a first mirror device on the second sacrificial layer;
applying a third sacrificial layer on the first mirror device;
arranging a second mirror device on the third sacrificial layer in a plane-parallel fashion over the first mirror device at a first distance; and
removing the second sacrificial layer and the third sacrificial layer to form an inner region below the first and the second mirror device by an etching method, the inner region extending at least over a part of the first subregion, while leaving a region, remaining in the interferometer device, of the first sacrificial layer, of the second sacrificial layer and of the third sacrificial layer which form an intermediate layer region so that the first mirror device and the second mirror device are framed in an outer region of the intermediate layer region or are arranged thereon, and the first subregion extends one of fully and partly in the inner region and is arranged on the intermediate layer region, and the second subregion extends in the outer region of the intermediate layer region.

12. The method as claimed in claim 11, wherein a recess is formed in the first subregion and in an optical region of the interferometer device, and the first sacrificial layer is removed in this recess.
